(19) United States
(12) Patent Application Publication
(10) Pub. No.: US 2009/0116973 A1
(43) Pub. Date: May 7, 2009

(54) Pump for Shock Absorbers

(76) Inventor: Scott Wu, Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/934,114

(22) Filed: Nov. 2, 2007

(51) Int. Cl. F04B 41/00; B60G 17/00

(52) U.S. Cl. 417/236; 267/64.16

(57) ABSTRACT

A pump for use in combination with shock absorbers comprises a joint having a first portion, a second portion and a channel extending therethrough. A tube receives the second portion of the joint. A collar includes a first end and a second end, with the first end pivotally receiving the first portion of the joint. An adapter is positioned above the first portion of the joint and includes a passage therein and an air anti-leak member for preventing air leak between the channel and the passage when pumping. A cap is engaged with the second end of the collar and including an opening into which a valve is adapted to insert and thereafter engages with the nozzle head.

### BACKGROUND OF THE INVENTION

1. Field of the Invention

The present invention relates to a pump for use in combination with shock absorbers on a bicycle.

2. Description of the Related Art

Referring to FIG. 1, a known pump used for pumping shock absorbers on a bicycle includes a head 91, a barrel 92, and a joint interposed between the head 91 and the barrel 92. The user connects the head 91 to the shock absorber during operation, air is then pumped from the barrel to the head via an air passage 93 defined in the joint. While the device may be suitable for the purpose for which it is designed, the pump is typically not suitable for efficiently pumping the shock absorbers, as some shock absorbers are located at where limited working space is provided.

Taiwan Application No. 463878 discloses a pump for using in a limited working space-in that the pump comprises a pivotally moveable head. However, the pump is not designed for the purpose of the present invention. Furthermore, one problem with such a pump is that two o-rings 18 and 36 disposed within the pump for preventing air leak are squeezed at all times and inhibit the pivoting of the head. Meanwhile, pivoting the head causes the wear of the o-rings and the wear of the o-rings result air leak within the pump.

The present invention is, therefore, intended to obviate or at least alleviate the problems encountered in the prior art.

### SUMMARY OF THE INVENTION

The present invention overcomes the shortcomings of the prior arts by providing a pump comprising a joint connected between a head and the tube. The joint allows the head to be angled with respect to the tube. Also, an air anti-leak member which prevents air leak between the head and the joint, is avoided from being squeezed or abraded when the pump is not in use with a shock absorber.

An objective of the present invention is to provide a pump that is suitable for use in combination with shock absorbers located at where limited working space is provided.

Another objective of the present invention is to provide a pump having an air anti-leak member, wherein the pump allows the air anti-leak member to be avoided from abrasion when not in use with a shock absorber.

Other objectives, advantages, and novel features of the invention will become more apparent from the following detailed description when taken in conjunction with the accompanying drawings.

### BRIEF DESCRIPTION OF THE DRAWINGS

FIG. 1 is a conventional pump for use in combination with shock absorbers on a bicycle.

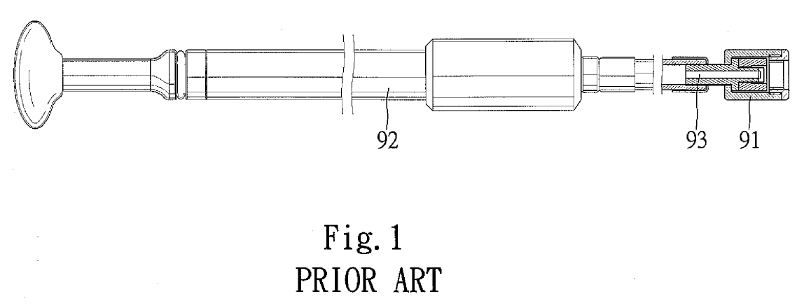

FIG. 2 is a partial, perspective view of a pump in accordance with the present invention.

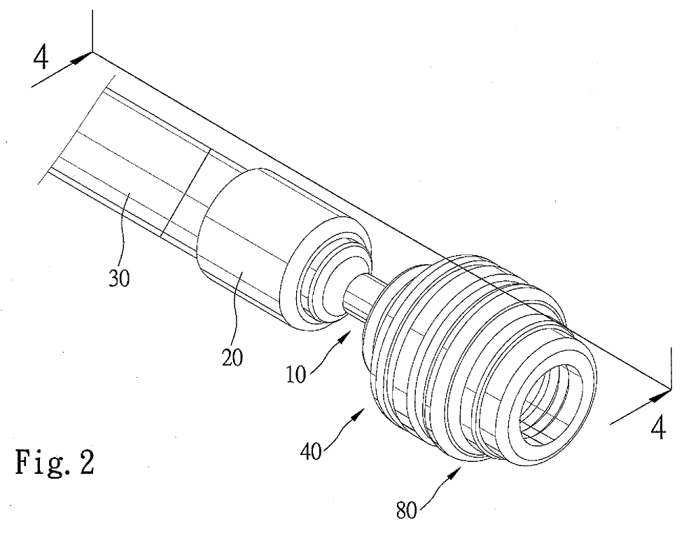

FIG. 3 is an exploded view of the pump shown in FIG. 2.

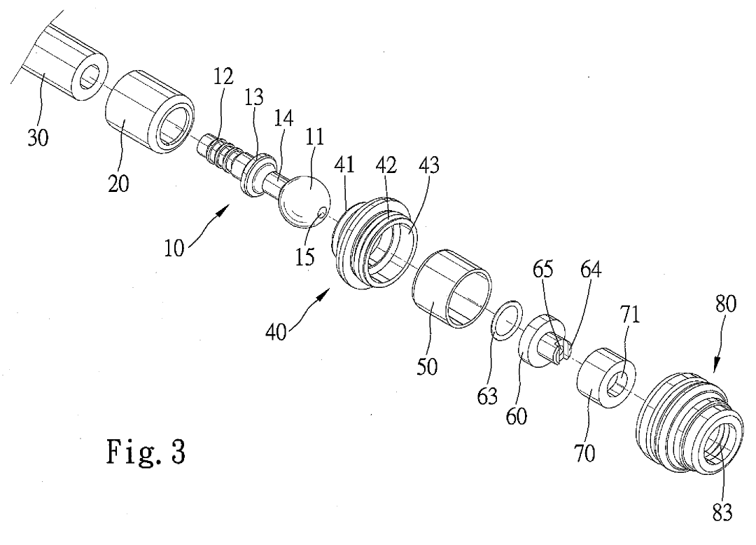

FIG. 4 is a cross-sectional view taken along line 4-4 of FIG. 2.

FIG. 5 is similar to FIG. 4 but shows a different air anti-leak member.

FIG. 6 is similar to FIG. 5, but shows the pump in another position.

FIG. 7 is similar to FIG. 5, but shows the pump in yet another position.

FIG. 8 is similar to FIG. 7, but shows the pump incorporating with a nozzle head.

FIG. 9 is a perspective view showing the use of the pump in combination with a shock absorber on a bicycle.

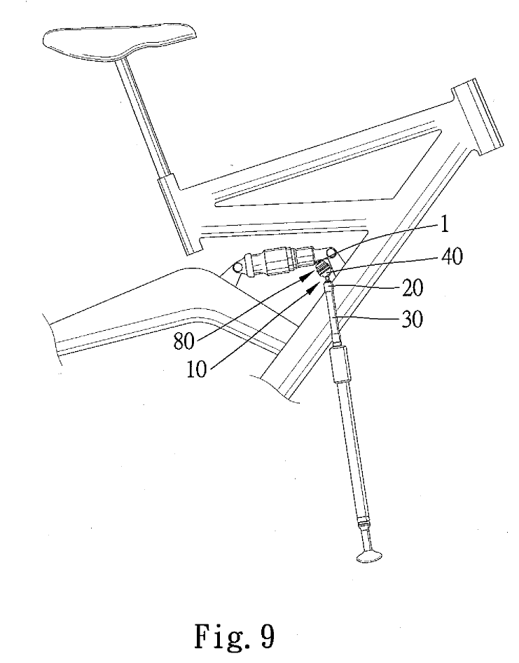

### DETAILED DESCRIPTION OF THE PREFERRED EMBODIMENT

Referring to the drawings, a pump for use in combination with shock absorbers on a bicycle comprises a joint 10, a tube 30 and a ferrule 20 attaching the joint 10 to the tube 30. The joint 10 has a shaft 12 inserted into an orifice defined by the ferrule 20 and be received within the tube 30, and a shoulder 13 disposed outside the orifice and mounted against the ferrule 20. The joint 10 further has a neck 14 extending outward of the tube 30 from the shoulder 13 and formed with a spheroid 11, with the spheroid 11 has a transverse distance greater than that of the neck 14, and a channel 15 which extends from the shaft 12 to the spheroid 11 entirely.

On the spheroid 11, there is fixed a collar 40. The collar 40 includes a first end 41 adapted to allow insertion of the spheroid 11 into a compartment 43 therein and a second end 42. Further, the compartment 43 has a sleeve 50 partially received in the compartment 43 and partially extended outward from the second end 42 of the collar 40.

An adapter 60 is inserted into and surrounded by the sleeve 50 and includes a nozzle head 64 and a base (not numbered). The base has a first indentation 61 and an air anti-leak member 63 is received therein. In the preferred embodiment, the air anti-leak member is an O-ring. The base further has a dome-shaped second indentation 62 in communication with the first indentation 61. The dome-shaped second indentation 62 defines an arcuate surface 621. Further, a resilient plug 70 is fitted around the nozzle head 64, with the nozzle head 64 being received in a hole defined by the resilient plug 70.

As also seen, the pump has a cap 80 having a recess 82 therein and an engaging portion 81 for snugly attaching to the second end 42 of the collar 40. Therefore, the sleeve 50, the adapter 60 and the resilient plug 70 are received in the compartment 43 and the recess 82 and securely retained therein. The cap 80 further includes an opening 83 into which the nozzle 1 is adapted to insert and thereafter engages with the nozzle head 64 of the adapter 60.

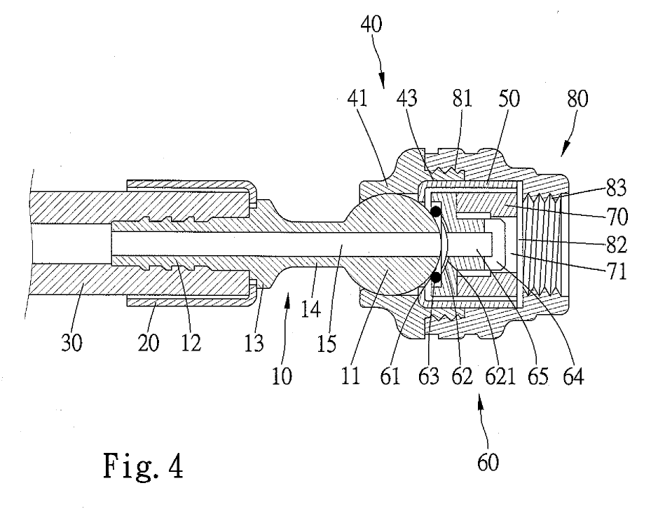

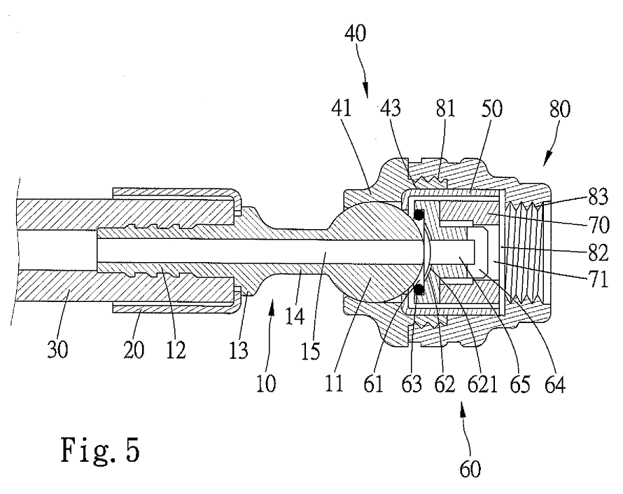

In FIGS. 4 and 5, it will be observed that the air anti-leak member 63 received in the first indentation 61 serves to prevent air leak between channel 15 and passage 65. The air anti-leak member 63 can be of a type loosely touched or of another type spaced from the spheroid 11. Noted that because the air anti-leak member 63 is loosely touched against the spheroid 11, pivoting of the spheroid 11 thus have no detrimental effect on wearing the air anti-leak member 63.

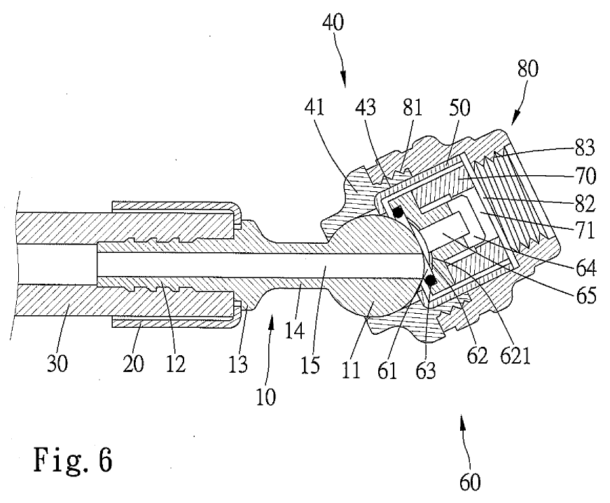

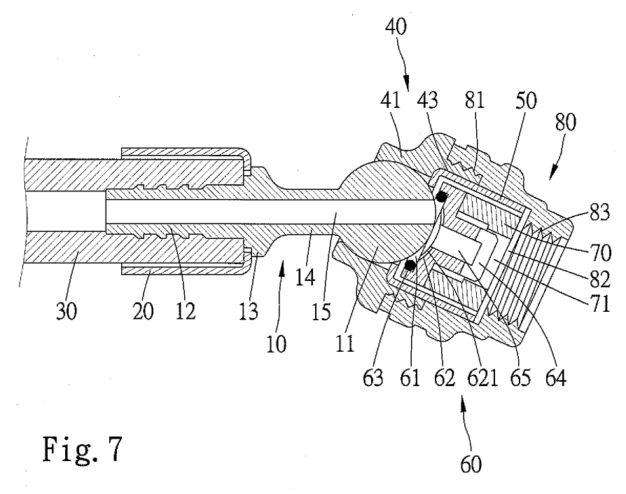

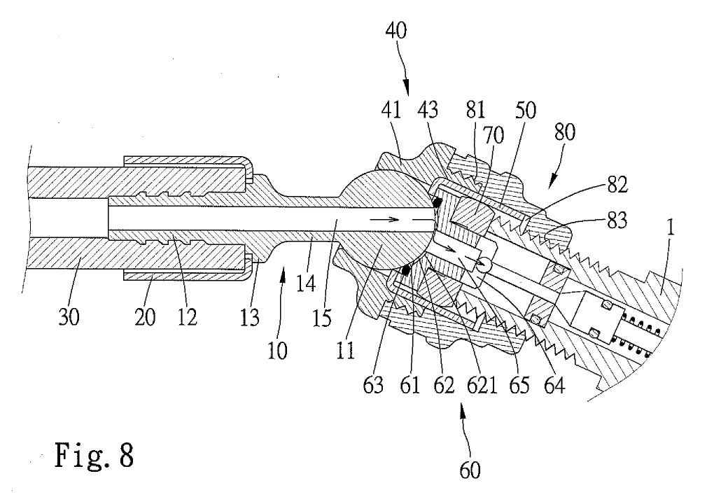

In FIGS. 6 and 7, the collar 40 is pivotably rotated at various angles with respect to the joint 10, therefore enabling the use in combination with shock absorbers located at where limited working space is provided (as best seen in FIG. 8).

In FIG. 7, the pump is connected to the nozzle 1, the nozzle 1 is threadly inserted into the opening 83 of the cap 80 and located against the nozzle head 64 of the collar 60 in a fluidly communicated manner. The resilient plug 70 is depressed and expands radially to touch against inner wall of the sleeve 50. The collar 60 is moved toward the spheroid 11 of the joint 10, so that the air anti-leak member 13 which is originally spaced from the spheroid 11 is moved to touch against the spheroid 11 for preventing leakage of pumped air flown from channel 15 to a passage in the collar 40.

Meanwhile, it is to be noted that if the collar 40 is angled with respect to the joint, as in FIG. 7, the pumped air will travel from the channel 15 to the passage 65 through an interstice defined between the arcuate surface 621 of the second indentation 62 of the collar 60 and the peripheral wall of the spheroid 11 (as indicated by the arrows).

While the specific embodiments have been illustrated and described, numerous modifications come to mind without significantly departing from the spirit of invention and the scope of invention is only limited by the scope of accompanying claims.

What is claimed is:

1. A pump for use in combination with shock absorbers comprising:
a joint including a first portion, a second portion and a channel extending therethrough;
a tube receiving the second portion of the joint;
a collar including a first end and a second end, with the first end pivotally receiving the first portion of the joint;
an adapter positioned above the first portion of the joint and including an a passage therein, with the adapter further including an air anti-leak member for preventing air leak between the channel and the passage when pumping;
a cap engaged with the second end of the collar and including an opening into which a valve is adapted to insert and thereafter engages with the nozzle head; and
wherein the adaptor is urged toward the first portion of the joint by the valve and the air anti-leak member is thereafter tightly pressed between the adapter and the first portion of the joint for fluidly sealing leak between the channel and the passage.

2. The pump as claimed in claim 1 further includes a first indentation for receiving the air anti-leak member and a second indentation in communication with the first indentation.

3. The pump as claimed in claim 2 wherein the second indentation comprises a wall and wherein the first portion of the joint comprises a peripheral wall, with an interstice defined between the wall and the peripheral wall, and with air pumped from the channel to the passage via the interstice when the passage is angled out of alignment with respect to channel for using in combination with a valve that lacks good working space.

4. The pump as claimed in claim 3 wherein the first portion of the joint is in a form of a spheroid and wherein the interstice is arcuate.

5. The pump as claimed in claim 1 wherein the collar is pivotable with respect to the joint at two positions, with one position at which the channel is aligned with the passage, and with one position at which the collar is out of alignment with the passage.

6. The pump as claimed in claim 1 further comprises a ferrule attaching the joint and the tube for secure engagement therebetween.

7. The pump as claimed in claim 1 further comprises a sleeve partially received in the collar and partially received in the cap.

8. The pump as claimed in claim 1 further comprises a resilient plug surrounding the nozzle head of the adapter.
